(19) United States
(12) Patent Application Publication
(10) Pub. No.: US 2023/0301854 A1
(43) Pub. Date: Sep. 28, 2023

(54) ANTI-DECUBITUS DEVICE AND ANTI-DECUBITUS SYSTEM

(71) Applicants: Patrizia TANI, Roma (IT); Marco SICLARI, Roma (IT); Gianluca RENZI, Civitavecchia (IT); Alessandro CARUCCI, Civitavecchia (IT)

(72) Inventors: Alessandro CARUCCI, Civitavecchia (IT); Gianluca RENZI, Civitavecchia (IT); Marco SICLARI, Roma (IT); Patrizia TANI, Roma (IT); Renato BIFERALI, Civitavecchia (IT); Francesco RENNA, Torino (IT)

(21) Appl. No.: 18/020,868

(22) PCT Filed: Aug. 4, 2021
(86) PCT No.: PCT/IB2021/057144

§ 371 Date: Feb. 10, 2023

(30) Foreign Application Priority Data
Aug. 12, 2020 (IT) 102020000020065

(51) Int. Cl. A61G 7/057

(52) U.S. Cl. CPC A61G 7/0573; A61G 7/05761

(57) ABSTRACT

The present invention relates to an anti-decubitus device for a patient lying in a bed which bed has a main development direction, with respect to which it has lateral edges substantially parallel, and a front edge and a rear edge substantially transverse; the device comprising a flexible element which, in use, is interposed between said bed and said patient, and at least one handling unit arranged in proximity of at least one respective lateral edge, and having a length extension along a direction parallel to said direction less than the length of said lateral edge.

### TECHNICAL FIELD OF THE INVENTION

The present invention relates to an anti-decubitus device and to an anti-decubitus system for bedridden patients.

### BACKGROUND

The formation of pressure sores is a largest issue for long-term patients who are forced to lie in bed. Staying in the same position for a long time, the body parts resting on the surface of the bed are not sufficiently ventilated and with time real bloody sores form on the skin, capable of becoming infected and generating pain and other problems for the patient.

Therefore, continuous care is required for the long-term patient, which involves moving the body in different positions and cleaning and disinfecting the body parts at risk.

Apparatus or devices are known which can move the patient automatically, by means of suitable mobile structures which can be applied to beds and which can be operated by means of electric motors. Such structures have structural elements positioned around the bed, both at the sides and at the foot of the bed. The structures are associated with a sheet placed between the patient and the bed. The structures are configured in such a way as to wrap/unwind the sheet so as to move the patient from one position to another.

Known apparatuses or devices have drawbacks.

A first drawback is due to the structures, which have parts intended to be placed all around the bed, which can be applied only to beds having specific dimensional requirements and cannot be adapted to any type of bed. This implies that the known device is not much adaptable and, in case of requiring to be applied to beds with incompatible dimensions, it requires considerable structural modifications.

It is also known the need to be able to move the patient to different positions in an easy, fast and effective way.

Furthermore, other alternative systems involving the use of particular pneumatic mattresses capable of pushing the patient for the movement thereof are known. Such systems can only be integrated into beds with compatible structures and do not allow the patient to be lifted from the bed surface, although only rotated and pushed.

At present, the operations of changing underwear, changing sheets and cleaning the bed and all operations relating to the repositioning of the patient take place without the aid of automated systems; specifically, two operators use a cloth placed between the patient and the mattress. Several of their movements can be harmful if done with excessive energy.

### SUMMARY OF THE INVENTION

The technical problem posed and solved by the present invention is therefore to provide an adaptive kinetic device for architecture that allows to overcome the drawbacks above mentioned with reference to the known art.

This problem is solved by the anti-decubitus device according to claim 1.

The present invention further provides an anti-decubitus system according to claim 14.

Preferred features of the present invention are the subject of the dependent claims.

The present invention provides several relevant advantages. The main advantage is that the devised device can be easily adapted to any type of bed, independently of the length of the latter.

The handling units listed in claim 1, indeed, have no parts intended to be positioned beyond the length of the bed sides. The device 1, therefore, is suitable for any type of bed.

Furthermore, the handling units, the drive means and the control unit operate at low voltage, ensuring the patient maximum safety during the device operation.

Eventually, the device is made from parts (handling units and flexible elements) which can be easily disassembled and re-assembled, therefore easily portable. Consequently, the device can be provided in the form of a kit comprising one or more handling units as described below and one or more flexible elements.

The present invention involves various and apparent advantages with respect to the known art that, together with the characteristics and methods of use of the present invention, will become apparent from the following detailed description of its preferred embodiments, presented by way of non-limiting example.

Other advantages, characteristics and methods of use of the present invention will become apparent from the following detailed description of several embodiments, presented by way of non-limiting examples.

### BRIEF DESCRIPTION OF THE FIGURES

Reference will be made to the figures of the attached drawings, in which:

FIG. 1 shows an axonometric view of the device according to the present invention;

FIGS. 2A and 2B illustrate details of the device according to the present invention;

FIG. 2C illustrates a detail of a device according to the present invention;

FIGS. 3, 4, 5 and 6 show different operating modes of the device of FIG. 1 according to the present invention;

FIGS. 7, 8 and 9 show different operating modes of a system comprising two devices according to the present invention.

The thicknesses and curvatures shown in the figures above introduced should be intended as merely examples, are generally magnified and not necessarily shown in proportion.

### DETAILED DESCRIPTION OF PREFERRED EMBODIMENTS

Various embodiments and variants of the invention will be hereafter described, and this with reference to the figures introduced above.

Similar components are denoted in the various figures by the same numerical reference.

In the following detailed description, further embodiments and variants with respect to embodiments and variants already discussed within the same description will be illustrated limitedly to the differences with what has already been disclosed.

Furthermore, the different embodiments and variants described below can be used in combination, where suitable.

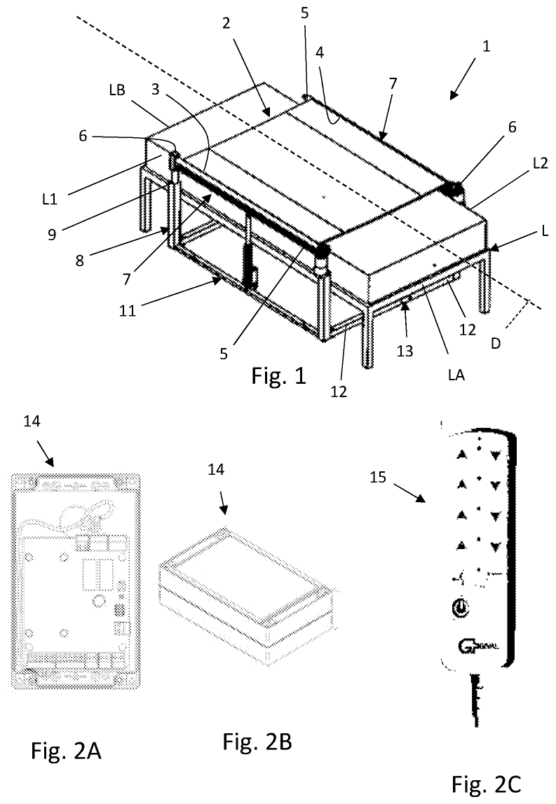

With initial reference to FIG. 1, according to an embodiment of the invention an anti-decubitus device for a patient P lying in a bed L is overall denoted by 1. As shown in FIG. 1, the bed L has a main development direction D, with respect to which it has lateral edges L1, L2 substantially parallel, and a front edge LA and a rear edge LB substantially transverse.

The device 1 comprises a flexible element 2 which, in use, is interposed between the bed L, in particular the surface of the bed, and the patient P. The flexible element 2 comprises extremal edges 3, 4 opposed, positioned at respective lateral edges L1, L2.

Usefully, the flexible element 2 has a length extension along a direction parallel to the direction D of maximum 125 cm and can be of the type of a sheet combined by three portions, two of which are made of a sheet of flexible, washable and tear-resistant material, connected to one end of the rotary rollers and to the other end, by means of double linear Velcro, a portion composed of a double layer of washable, breathable and hypoallergenic cotton anti-bedsore sheet, so as to ensure adequate breathability and ventilation to the skin of the patient P. The configuration of the flexible element 2 helps the operator to change the central portion of the flexible element 2 without the need to carry out any intervention on the rotary rollers.

The device 1 further comprises at least one handling unit 7 associated at least with the first extremal edge 3 or with the second extremal edge 4. The handling unit 7 is configured to raise/lower and/or rotate the flexible element 2. The handling unit, then, is arranged in proximity to at least one respective lateral edge L1, L2, and has a length extension along a direction parallel to the direction D that is less than the length of the lateral edge L1, L2. Thereby, the device 1 is compatible with all types of beds on the market and can also be adapted to existing beds. Consequently, the device 1 has an improved ease of use.

Advantageously, the handling unit 7 has a length extension along a direction parallel to the direction D that is between 40 cm and 180 cm. Preferably, the aforementioned length extension is between 100 cm and 150 cm. Usefully, the aforementioned length extension is approximately equal to 130 cm. Such length values make the device 1 particularly suitable for most beds available on the market.

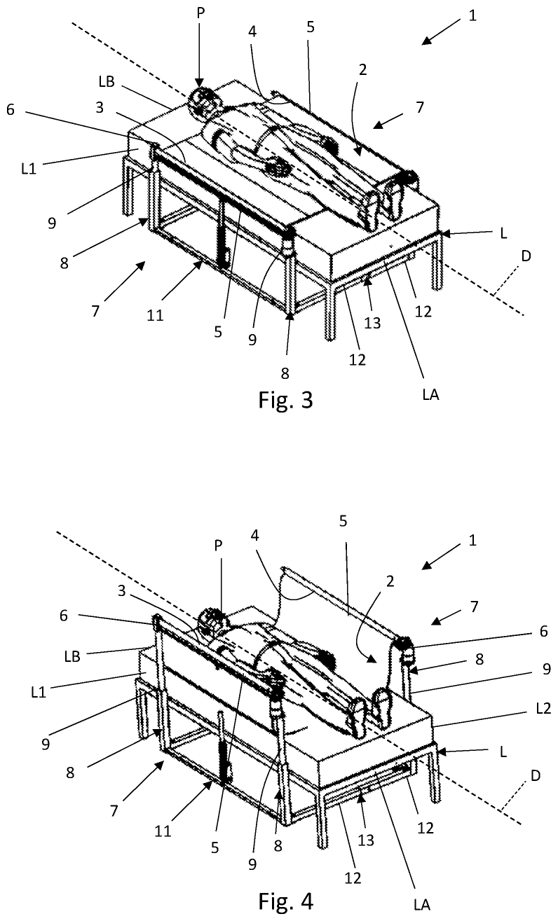

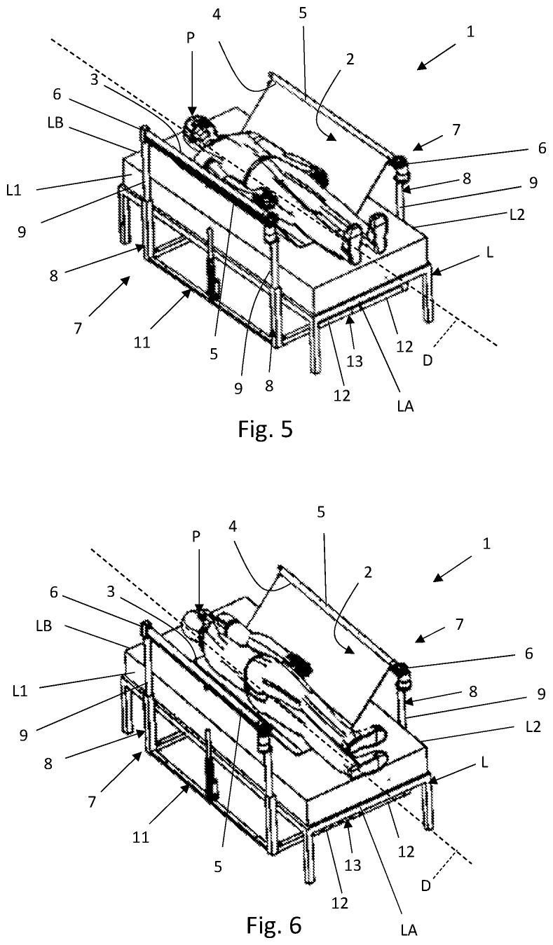

The overall configuration is such that the flexible element 2 is raised/lowered and wrapped/unwound by the handling unit 7 and the patient is brought from a starting position (see FIG. 3) to a subsequent position (see FIG. 6) by means of the lifting/lowering and wrapping/unwinding of flexible element 2 (FIG. 4 and FIG. 5).

The handling unit 7 can rise above the bed L and, by means of a lifting (FIG. 4) and a rotation (FIG. 5), can raise the flexible element 2 up to about 35 cm from the bed L surface. thereby, the patient P is moved away from the bed L surface and is brought, by means of coordinated wrappings/unwindings of the lateral edges 3, 4, to a position different from the starting position.

According to preferred embodiments, for example as illustrated in FIGS. 1, 3, 4, 5 and 6, the handling unit 7 may comprise a winding roller 5 associated with one of the extremal edges 3, 4. The roller 5 may be arranged in proximity of the respective lateral edge L1, L2 and is configured to wrap/unwind the flexible element 2. Preferably the roller 5 develops substantially parallel to the direction D, providing the handling unit 7 with a development substantially parallel to this direction D and, therefore, a greater adaptability of device 1 to bed L.

Furthermore, the handling unit 7 may comprise a lifting structure 8, associated with the roller 5. The lifting structure 8 may be usefully placed near the lateral edge L1, L2. Preferably, the structure 8 may be variable between a lowered position wherein it has a minimum height, as for example illustrated in FIG. 3, and a raised position wherein it has a maximum height, as for example illustrated in FIGS. 4, 5 and 6. Advantageously, when the lifting structure 8 is in raised position, the flexible element 2 may be spaced from the bed L surface by about 30 cm or 35 cm, so that the patient can be raised and an aeration of the body parts previously placed in contact with the bed L can be allowed.

Usefully, the lifting structure 8 may comprise at least one telescopic rod 9 fixed to the roller 5. Rod 9 can lengthen/shorten and, consequently, raise, lower the roller 5.

Advantageously, the lifting structure 8 comprises two rods 9 fixed to the distal ends of the roller 5. Thereby, the lifting/lowering thrusts are evenly distributed along the roller 5 body and, consequently, its operation is improved.

In a preferred embodiment, the handling unit 7 comprises two lifting structures 8 inside which respective pairs of telescopic rods 9 fixed to the distal ends of the roller 5 slide, so as the lifting/lowering thrusts are evenly distributed along the body of the roller 5. In this preferred embodiment, the presence of a double lifting structure 8 allows to improve the wrapping/unwinding of the flexible element 2, facilitating the movement of the patient from one position to another.

The telescopic rods 9 can lengthen/shorten and, consequently, raise, lower the roller 5. The lifting structure 8 may be usefully placed near the lateral edge L1, L2. When the telescopic rods 9 are in raised position, the flexible element 2 can be spaced from the bed L surface by about 35 cm, so as to be able to raise the patient and allow aeration of the body parts previously placed in contact with the bed L.

Different solutions, wherein, for example, the lifting structure 8 is provided with a greater or lesser number of rods 9, or in which the lifting structure 8 is provided with different lifting elements, for example cranking elements, or lifting levers, or other mechanically and kinematically equivalent solutions, are not excluded. Furthermore, the device 1 may be provided with movement means associated with the roller 5 and the lifting structure 8, configured to rotate the roller 5 and to move the lifting structure 8 from the lowered position to the raised position and vice versa.

Usefully, the movement means may comprise at least one linear actuator operatively connected to the lifting structure 8 for the lifting/lowering of the flexible element 2.

In preferred embodiments, the linear actuator is inserted inside the rod 9 and is configured to lengthen/shorten the same rod so as to bring the lifting structure 8 from the lowered position to the raised position and vice versa. Alternative solutions in which there are linear actuators arranged externally to the rod are not excluded.

Advantageously, the movement means may comprise three motor elements 6 operatively connected to the roller 5 and configured to rotate alternately clockwise/counter clockwise the same roller 5 in order to wrap/unwind the flexible element 2.

With reference to preferred embodiments, for example the one illustrated in the Figures, a motor element 6 is mounted onto one end of the roller 5.

Alternative solutions wherein the motor element 6 has a different arrangement from the one illustrated are not excluded.

Advantageously, the movement means are configured to be operated independently of each other. With reference to preferred embodiments, among which the one illustrated in the Figures, the linear actuators and the motor elements 6 can be operated independently, so as to determine different movements of the flexible element 2 and, therefore, allowing different positions of the patient P.

Preferably, the handling unit 7 may comprise a base portion 11 whereon the lifting structure 8 is mounted. The base portion 11 may usefully comprise at least one transverse element 12 with respect to the direction D. The base portion 11 may be of the type of a frame laying on the ground by means of 4 threaded feet, or a base of a different type, in any case laying on the ground in order to support the entire device 1 in position.

With reference to preferred embodiments, among which the one illustrated in the Figures, the rods 9 can be grafted onto the base portion 11 and fixed thereto.

Usefully, the transverse element 12 may comprise attachment means 13 of variable length. Thereby the transverse element 12 can vary in length, facilitating the adjustment to any bed type on the market. Furthermore, the attachment means 13 may be configured to connect several transverse elements 12 to each other, for example to join two handling units 7 and make the device 1 more rigid and stable. The attachment means 13 may be of the type of a plurality of stackable holes and bolts, or other similar elements for connection, which can be inserted into the holes to configure a locking clamp. Alternatively, attachment means 13 may comprise three engagement systems, or clips, or other technically equivalent elements configured to realize an attachment to the transverse element 12.

According to preferred embodiments, for example as shown in the Figures, the device 1 can comprise at least one control unit 14 configured to operate the handling unit 7. The configuration is such that a user can send input data to the control unit 14 in order to operate and control the handling unit 7, lifting/lowering and wrapping/unwinding the flexible element 2. FIGS. 2A and 2B illustrates a possible embodiment wherein the control unit 14 is of the type of an electronic control unit, although other control units 14 having different shapes are not excluded.

The control unit 14 can further comprise a data management and processing unit configured to receive and process the patient's biometric data. The data management and processing unit can be configured to receive biometric data from the patient by means of dedicated sensors and to transmit output data relating to the biometric data, for example by means of radio frequency transmission means such as Bluetooth, Wi-Fi, GSM, or other means of radio frequency transmission. In such case, the control unit can comprise three biometric data detection sensors, microprocessors and radio frequency emitting elements, configured to detect, process and transmit the biometric data of the patient P.

According to a preferred embodiment, illustrated in FIGS. 1, 3, 4, 5 and 6, the device 1 may comprise two handling units 7 arranged symmetrically with respect to the bed L. In particular, the two handling units 7 are each arranged in proximity to a respective lateral edge L1, L2 and are each associated with a respective extremal edge 3, 4.

Advantageously, the transverse elements 12 of the two handling units 7 may be connected by means of the attachment means 13. Thereby, the base portions 11 of each handling unit are rigidly connected, giving the device 1 greater stability and rigidity. Furthermore, the attachment means 13, being of variable length, allows the device 1 to adapt to any bed available on the market.

The two handling units 7 can be operated independently of each other, allowing several ways of handling the patient P. In particular, the rollers 5 and the telescopic rods 9 of each handling unit 7 can be operated independently and allow, therefore, a plurality of movements useful for moving the patient P from one position to another.

Usefully, the control unit 14 is configured to independently operate the movement means and, therefore, independently control and manage the drive of the rollers 5 and the lifting structures 8, in particular of the telescopic rods 9.

Furthermore, the device 1 can comprise a remote control unit 15 operatively connected to the control unit 14 and configured to send/receive input data to/from the control unit 14.

An operator, therefore, can control the movement of patient P by means of the remote control unit 15, for example while staying out of the room. This solution is particularly convenient for cases of contagious patients, in intensive care or in any case bedridden in environments which must remain protected and uncontaminated.

FIG. 2C shows an example of a remote control unit 15, particularly of the type of a button remote control that can be connected to the control unit via a connection cable.

The remote control unit 15 may, alternatively, be a radio frequency remote control, or a tablet or smartphone specially configured to communicate with the control unit 14.

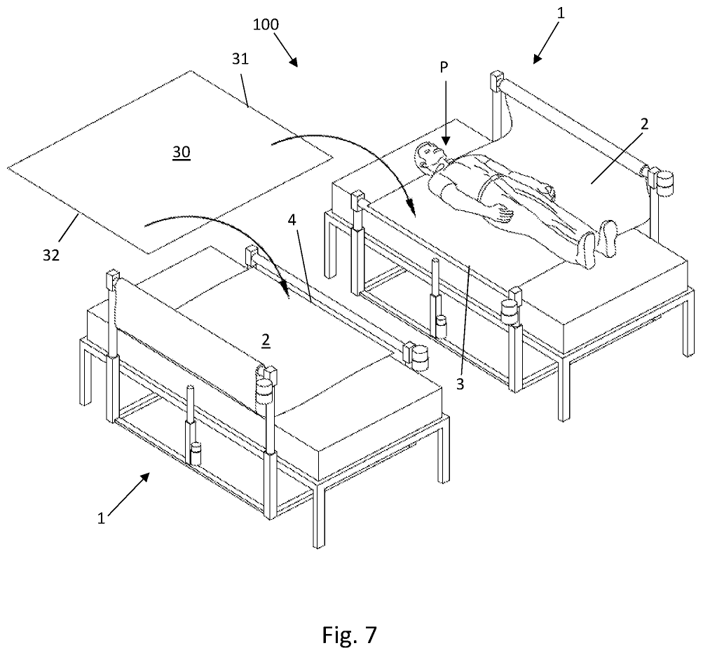

In accordance with a further advantageous aspect of the present invention, a system 100 is provided allowing the displacement of a patient P from a first bed associated with a first anti-decubitus device 1 to a second bed associated with a second anti-decubitus device 1, as shown in the series of FIGS. 7, 8 and 9. The anti-decubitus devices 1 are realized in accordance with what has already been described.

As mentioned, the first and second devices 1 each comprise a respective flexible element 2 and a respective handling unit 7. Each flexible element 2 bears first means for connection, which for example may be elements of a hook-and-loop closure (Velcro type), or other type of means such as laces or hooks/buttonholes, at its own extremal edge 3, 4. For each device 1, the means for connection is arranged on the extremal edges 3, 4 facing towards the other device 1, i.e. which are interposed between the two devices 1. Furthermore, such extremal edges 3, 4 bearing the first means for connection are released from movement means 7.

The system 100 comprises a further flexible component 30 realized according to what has already been indicated with reference to the flexible element 2, which has two terminal edges 31, 32, opposite to each other, positioned at their respective side edges.

The flexible component 30 bears, at both its terminal edges 31, 32, second means for connection configured to engage with the first means for connection of the flexible elements 2 of the two devices 1.

Therefore, the flexible component 30 can be connected to each of the flexible elements 2 of the first and second device 1, in order to interpose the flexible component 30 therebetween (FIG. 7).

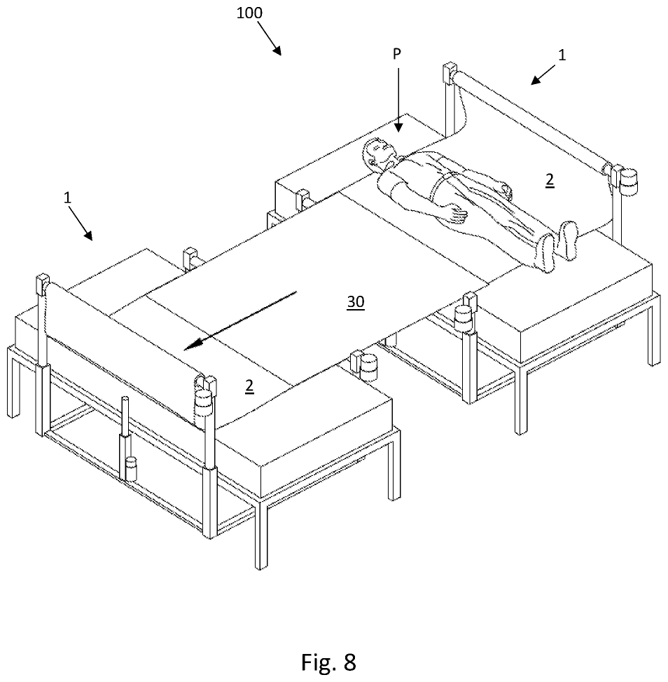

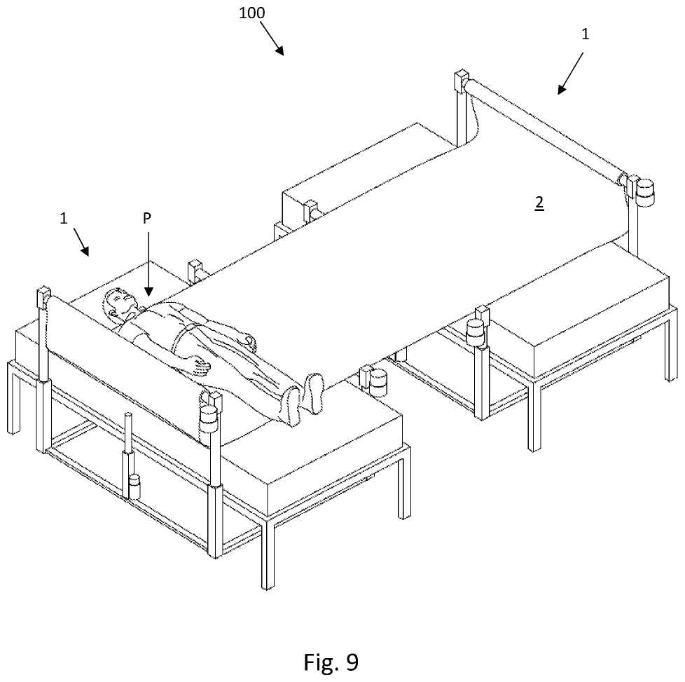

The overall configuration of the system 100 is such that the flexible elements 2 are raised/lowered and wrapped/unwound by the respective handling units 7 and the patient is brought from the first to the second device 1 (FIG. 8 and FIG. 9) thanks to the interposition of the flexible component 30. Obviously, in order to allow the patient to move from the first bed to the second bed, the lifting structures 8 of the handling units 7 placed at the extremal edges 3, 4 connected to the flexible component 30 are required to be lowered to a minimum.

In particular, the displacement of the patient can be achieved by means of a command sequence of the control unit, whereby firstly both the flexible elements 2 are wrapped by the rollers in an external position, bringing the patient in a position such as not to touch the mattress of the first bed. Once at a height, the patient is moved from the first bed to the second bed by means of a further control unit command, whereby the system wraps the roller of the second bed while unrolling that of the first bed. Once the position is reached, both rollers are unwound to lower the patient and position him onto the second bed. Eventually, the flexible component 30 is disconnected from the two flexible elements 2, and the latter are coupled again, at the extremal edges previously connected to the flexible component, to the rollers of the handling units 7 thereof. Advantageously, the system 100 allows the patient to be moved from one bed to another without any need to manually operate thereon.

The present invention has been hitherto described with reference to preferred embodiments. It should be understood that each of the technical characteristics implemented in the preferred embodiments, described here merely by way of example, may advantageously be combined, in a different way from what is described, also with other characteristics, to realize further embodiments still pertaining to the same inventive core. It should be understood, therefore, that there may be other embodiments pertaining to the same inventive core, as defined by the scope of protection of the claims set forth below.

1. An anti-decubitus device for a patient lying in a bed whose bed has a main development direction, with respect to which it has substantially parallel lateral edges, and a front edge and a rear edge substantially transverse, the device comprising:
a flexible element which, in use, is interposed between said bed and said patient, the flexible element comprising opposite first and second extremal edges positioned at respective lateral edges;
at least one handling unit associated with at least one of said first extremal edge or said second extremal edge, configured to raise/lower and/or rotate said flexible element, arranged in proximity to at least one respective lateral edge, and having a length extension along a direction parallel to said direction less than the length of said lateral edge; and
an overall configuration being such that said flexible element is raised/lowered and wrapped/unwound by said handling unit and said patient is led from a starting position to a subsequent position by lifting/lowering and wrapping/unwinding of said flexible element.

2. The anti-decubitus device according to claim 1, wherein said handling unit has a length extension along a direction parallel to said direction which is between 40 cm and 180 cm, preferably, it is between 100 cm and 150 cm.

3. The anti-decubitus device according to claim 1, wherein said handling unit comprises:
a winding roller associated with one of said extremal edges, said roller being arranged in proximity to said lateral edge configured to wind/unwind said flexible element;
a lifting structure composed of a fixed structure and a telescopic rod, the latter associated with said roller, placed in proximity to said lateral edge and variable between a lowered position in which it has a minimum height, and a raised position in which it has a maximum height; and
moving devices associated with said roller and with said telescopic rod, configured to rotate said roller and to move said telescopic rod from said lowered position to said raised position and vice versa.

4. The anti-decubitus device according to claim 3, in which said roller develops substantially parallel to said direction.

5. The anti-decubitus device according to claim 3, in which said lifting structure comprises at least one telescopic rod fixed to said roller.

6. The anti-decubitus device according to claim 5, in which said moving devices comprises at least one linear actuator operatively connected to said lifting structure for lifting/lowering said flexible element, and at least one motor element operatively connected to said roller for the rotation of the roller to wind/unwind said flexible element, the configuration being such that said linear actuator and said motor element can be operated independently of each other.

7. The anti-decubitus device according to claim 5, in which said lifting structure comprises two of said rods fixed to distal ends of said roller.

8. The anti-decubitus device according to claim 3, in which said handling unit comprises a base portion whereon said lifting structure is mounted, the base portion comprising at least one transverse element to said direction.

9. The anti-decubitus device according to claim 8, in which said transverse element comprises attachment devices of variable length.

10. The anti-decubitus device according to claim 1, comprising two handling units arranged symmetrically with respect to said bed.

11. The anti-decubitus device according to claim 10, in which transverse elements of said two handling units are connected by attachment devices.

12. The anti-decubitus device according to claim 1, comprising at least one control unit configured to operate said handling unit.

13. The anti-decubitus device according to claim 12, comprising a remote control unit operatively connected to said control unit and configured to send/receive input data to/from said control unit.

14. A system comprising a flexible component and a first and a second device according to claim 1, each comprising a respective flexible element and a respective handling unit, in which each flexible element bears first elements for connection at an extremal edge not constrained to said handling unit,
said flexible component bearing at both its terminal edges second elements for connection configured to engage with said first elements for connection, in such a way as to be able to connect said flexible component to the flexible elements of the first and second device and to be able to interpose said flexible component between said first and second device, and
an overall configuration of the system being such that said flexible elements are raised/lowered and wrapped/unwound by the respective handling units in order to allow a movement of a patient from the first to the second device.
